(19) United States
(12) Patent Application Publication
(10) Pub. No.: US 2026/0349934 A1
(43) Pub. Date: Nov. 5, 2026

(54) DEVICE, SYSTEM AND METHOD FOR TRANSLATING SEQUESTERED ADDRESSES

(71) Applicant: Intel Products IP LLC, Santa Clara, CA (US)

(72) Inventors: Siva Bhanu Krishna Boga, Folsom, CA (US); Sai Supriya Enuguru, Portland, OR (US); Rupin H. Vakharwala, Hillsboro, OR (US); Avishai Klimor Maman, Kfar-Tavor (IL); Ashish Gupta, San Jose, CA (US); Ravi Kolagotla, Austin, TX (US); Anoop Mukker, Folsom, CA (US)

(73) Assignee: Intel Products IP LLC, Santa Clara, CA (US)

(21) Appl. No.: 19/721,824

(22) Filed: Jun. 26, 2026

(51) Int. Cl. G06F 12/14

(52) U.S. Cl. CPC G06F 12/145; G06F 2212/68

(57) ABSTRACT

Techniques and mechanisms for sequestering addresses for translation with circuitry which is coupled to a memory management unit (MMU). In an embodiment, a filter unit identifies addresses which are each to be translated. The filter unit maintains a registry of filters to be used for determining whether a given address is to be sequestered, rather than provided to a translation lookaside buffer (TLB) pipeline of a MMU. A precedent address, which is in an address set that does not correspond to any currently enabled filter in the registry, is sent to the MMU for translation, and also results in the registration of a filter for the address set. A subsequent address, which is in the address set, is sequestered based on the filter. In another embodiment, a translation of the precedent address by the MMU results in the filter unit translating the sequestered addresses, and a deregistering of the filter.

### BACKGROUND

### 1. Technical Field

This disclosure generally relates to processor operations and more particularly, but not exclusively, to address translation operations in support of memory access requests.

### 2. Background Art

Modern computer devices are able to support various technologies which utilize a memory management unit (MMU) that supports communication of memory access requests from a requestor resource to a memory resource. Virtualization is one technology which enables a processor core, or an input-output (IO) device, to communicate memory access requests which have respective addresses that are subsequently translated. A MMU—such as an input-output memory management unit (IOMMU)—usually translates a virtual address into a corresponding physical address in order to facilitate servicing of a memory access request. In a typical scenario, a MMU maintains a translation lookaside buffer (TLB) which caches address translations that are searchable, based on a given virtual address, for the purpose of identifying a corresponding physical address. In the case of a TLB miss, such a MMU performs a page walk operation which looks up page tables in memory to identify the corresponding physical address.

Accesses to a memory by an IO device are usually for the purpose of a bulk direct memory access (DMA) transfer, for which consecutive memory access requests often rely on similar address translations each with the same TLB. A granularity of such DMA transfers is usually in a range of from 64 bytes (B) to 4 kilobytes (KB), although larger page sizes are often supported. As successive generations of memory access technologies continue to increase in size and capability, there is expected to be an increasing premium placed on improvements to address translation mechanisms.

### BRIEF DESCRIPTION OF THE DRAWINGS

The various embodiments of the present invention are illustrated by way of example, and not by way of limitation, in the figures of the accompanying drawings and in which:

FIG. 1 shows a functional block diagram illustrating features of a system to translate addresses according to an embodiment.

FIG. 2 shows a flow diagram illustrating features of a method to perform an address translation according to an embodiment.

FIG. 3 shows a functional block diagram illustrating features of a device to support the translation of addresses according to an embodiment.

FIG. 4 shows a functional block diagram illustrating features of a device to access information which facilitates address translation according to an embodiment.

FIGS. 5A, 5B show flow diagrams each illustrating features of a respective method for determining a processing by which an address is to be translated according to a corresponding embodiment.

FIG. 6 shows a functional block diagram illustrating features of a device which supports in-parallel evaluation of addresses to be translated according to an embodiment.

FIG. 7 illustrates an exemplary system.

FIG. 8 illustrates a block diagram of an example processor that may have more than one core and an integrated memory controller.

FIG. 9A is a block diagram illustrating both an exemplary in-order pipeline and an exemplary register renaming, out-of-order issue/execution pipeline according to examples.

FIG. 9B is a block diagram illustrating both an exemplary example of an in-order architecture core and an exemplary register renaming, out-of-order issue/execution architecture core to be included in a processor according to examples.

FIG. 10 illustrates examples of execution unit(s) circuitry.

FIG. 11 is a block diagram of a register architecture according to some examples.

### DETAILED DESCRIPTION

Embodiments discussed herein variously provide techniques and mechanisms for performing address translations. The description herein includes numerous details to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including a memory management unit which provides address translation functionality.

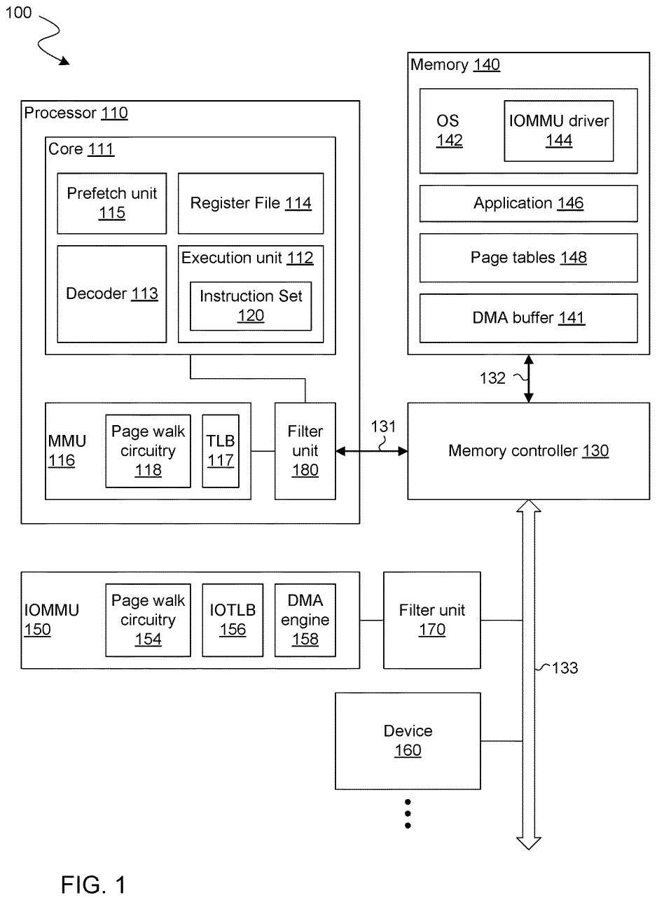

FIG. 1 illustrates features of a system 100 for translating addresses according to an embodiment. System 100 illustrates one example of an embodiment wherein circuitry is coupled to a memory management unit, wherein the circuitry is to conditionally sequester one or more addresses in lieu of sending said one or more addresses to a TLB pipeline. The sequestered one or more addresses are each in a particular address range, and are subject to being subsequently translated each based on a translation of another address which is in the same address range.

In some embodiments, system 100 includes, or supports operation in, any of various computing devices including handheld devices and devices for embedded applications. For example, system 100 provides or is to operate as a component of any of various devices including, but not limited to, a desktop computer, a tablet computer, a laptop computer, a netbook, a notebook computer, a personal digital assistant (PDA), a server, a workstation, a cellular telephone, a mobile computing device, a smart phone, an Internet Protocol device, a digital camera or the like. In various embodiments, some or all of system 100 is implemented with a system on a chip (SoC), a device package comprising one or more integrated circuit (IC) chips or, for example, a circuit board and one or more device packages which are coupled thereto.

As shown in FIG. 1, system 100 comprises a processor 110, a memory 140, a memory controller 130, and an input output memory management unit (IOMMU) 150 which are variously coupled to one another—e.g., via the illustrative processor bus 131, memory bus 132, and fabric 133 shown. Memory 140 is coupled to support operation as a main memory of system 100—e.g., wherein one or more regions of memory 140 are variously allocated each to provide the state of a respective software process which is executed with processor 110.

One embodiment is described in the context of a single processor desktop or server system, but alternative embodiments are included in a multiprocessor system. Processor 110, as one illustrative example, includes a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 110 is coupled to processor bus 131, which transmits data signals between the processor 110 and another component in system 100, such as memory controller 130, for storing data, address information and/or the like.

Processor 110 comprises one or more processor cores (including the illustrative core 111 shown) to execute instructions of system 100. The core 111 includes, but is not limited to, a pre-fetch unit 115 to fetch instructions, a decoder 113 to decode the instructions, an execution unit 112 to execute instructions and the like. A register file 114 of core 111 is to store different types of data in registers including, but not limited to, integer registers, floating-point registers, vector registers, banked registers, shadow registers, checkpoint registers, status registers, configuration registers, instruction pointer register, and/or the like. In various embodiments, processor 110 includes one or more caches (not shown) to cache instructions and/or data. For example, such one or more caches include, but are not limited to, level one, level two, and a last level cache (LLC), or any other configuration of cache memory within processor 110. Depending on the architecture, the processor 110 has a single internal cache or multiple levels of internal caches. In various embodiments, system 100 includes a combination of one or more caches which are internal to processor 110, and one or more caches which are external to processor 110.

In one example, core 111 comprises a floating-point unit. In another example, processor 110 does not have a floating-point unit. The processor 110, in one embodiment, includes a microcode (ucode) ROM to store microcode, which when executed, is to perform algorithms for certain macroinstructions or handle complex scenarios. Here, microcode is potentially updateable to handle logic bugs/fixes for processor 110.

Memory 140 illustrates any of a variety of one or more memory devices which are to provide some or all of a main memory of system 100. In an illustrative scenario according to one embodiment, various partitions and/or other allocated regions of memory 140 are setup, for example, at boot time by a basic input-output system (BIOS). Alternatively, processor 110 executes instructions of an operating system (OS), a virtual machine monitor (VMM) or other software agent which provides functionality to initialize, modify or otherwise determine an allocation of memory resources.

In an embodiment, processor 110 is coupled to (or alternatively, includes) a memory controller 130 which is to perform functions that enable processor 110 to access and communicate with memory 140. Memory 140 comprises random access memory (RAM) in a fixed or removable format. RAM includes volatile memory configured to hold information during the operation of system 100 such as, for example, static RAM (SRAM) or Dynamic RAM (DRAM). In some embodiments, memory controller 130 performs one or more operations which, for example, are adapted from conventional techniques for providing a processor with access to a main memory. Such conventional techniques are not detailed herein to avoid obscuring certain features of various embodiments which are not limited to said techniques.

In the example embodiment shown, a memory management unit (MMU) 116 of processor 110 provides functionality to manage access, via memory controller 130, to various regions of memory 140 by one or more processes which are executed with core 111 (and/or with one or more other cores of processor 110). By way of illustration and not limitation, MMU 116 determines an allocation of one or more pages in memory 140 to a given process, and (for example) configures one or more page tables-for example, comprising the illustrative page tables 148 shown-which comprise page table entries each for a corresponding page of the process. For a given one of such page entries, the page table entry maps a physical address for the corresponding page to a virtual address for the corresponding page.

In one such embodiment, MMU 116 supports the implementation of a virtual address space, addresses of which are each to be mapped to a corresponding address in a physical address space. For example, software executed with processor 110 variously references or otherwise uses virtual addresses, which MMU 116 translates into respective physical addresses for use in accessing corresponding pages of memory 140. In an embodiment, MMU 116 includes or otherwise has access to a translation lookaside buffer (TLB) 117 which provides a cache of recently accessed page table entries. Where a search of TLB 117 for a given address translation results in a miss, page walk circuitry 118 of MMU 116 performs a walk process which accesses one or more of page tables 148 to retrieve the address translation in question. In various embodiments, some or all operations by MMU 116 are adapted, for example, from conventional memory management techniques and/or mechanisms.

IOMMU 150 illustrates any of a variety of other integrated circuit resources which are suitable to enable direct memory access functionality of system 100. For example, system 100 further comprises (or alternatively, is to couple to) one or more devices-such as the illustrative device 160 shown-for which system 100 supports direct memory access. IOMMU 150 facilitates direct memory accesses by which device 160 reads data from, and/or writes data to, memory 140. In an embodiment, IOMMU 150 includes or otherwise has access to an input-output TLB (IOTLB) 156 which provides a cache of recently accessed page table entries. Where a search of IOTLB 156 for a given address translation results in a miss, page walk circuitry 154 of IOMMU 150 performs a walk process which accesses one or more of page tables 148 to retrieve the address translation in question.

Device 160 illustrates any of a variety of one or more endpoint devices, including a bus, or other endpoint hardware. In one embodiment, the one or more devices include one or more integrated devices (e.g., integrated with some or all of processor 110, memory 140 and IOMMU 150) such as processor graphics. Alternatively or in addition, the one or more devices include one or more discrete devices (such as PCIe™ devices or other attached devices), one or more legacy devices that do not support shared virtual memory, and/or the like. In one illustrative embodiment, the one or more devices include one or more network controller devices, storage controller devices, peripheral controller devices (like Universal Serial Bus (USB) controllers), media controller devices, display controllers, and/or the like.

In an illustrative scenario according to one embodiment, core 111 executes an operating system (OS) 142 which, for example, includes or otherwise supports execution of an IOMMU driver 144. In addition, one or more applications (including the illustrative application 146, for example) are executed with OS 142—e.g., wherein application 146 includes, or operates with, another driver process which facilitates operation of device 160. By way of illustration and not limitation, implementation of application 146 (or other such software process) includes execution unit 112 variously executing instructions of an instruction set 120.

At some point during operation of system 100, a region of memory 140 (in this example, the illustrative DMA buffer 141 shown) is allocated to be available for direct memory access by device 160 via IOMMU 150—e.g., wherein IOMMU driver 144 facilitates operation of IOMMU 150. For example, page tables 148 determine or otherwise indicate the allocation of various regions of memory 140—e.g., including DMA buffer 141-each for use by a respective software resource and/or hardware resource. In one such embodiment, page tables 148 specify or otherwise indicate a correspondence between addresses in different respective address spaces. In some embodiments, page tables 148 are provided-and/or DMA buffer 141 is otherwise allocated-by operations (e.g., performed with a BIOS, OS 142, application 146 and/or other suitable boot time or runtime process) which, for example, are adapted from conventional memory mapping techniques. Some embodiments are not limited to a particular mechanism by which, and/or basis on which, DMA buffer 141 and/or other regions of memory 140 are so allocated.

A DMA engine 158 of IOMMU 150 enables direct memory access by a given IO device to a region of memory 140 which is allocated for said access-e.g., wherein DMA engine 158 restricts direct memory access by device 160 to one or more memory regions including DMA buffer 141. DMA engine 158 comprises any of a variety of microcontrollers, state machines, programmable gate arrays, application specific integrated circuits and/or other suitable circuitry to provide direct memory access which reads data from, and/or writes data to, a region of memory 140 such as DMA buffer 141. Such direct memory access is provided based on address information such as that provided in the illustrative input-output translation lookaside buffer (IOTLB) 156 shown. For example, IOTLB 156 includes cached versions of one or more page table entries-e.g., each corresponding to a respective page table entry of page tables 148 which each specify or otherwise indicate a correspondence between a respective two addresses in different address spaces. In an embodiment, one such entry of IOTLB 156 identifies an address (e.g., a physical address) to access a memory location in DMA buffer 141.

In one example embodiment, a page table entry (or other suitable data structure) of page tables 148 specifies or otherwise indicates, for each of one or more memory locations of DMA buffer 141, a respective correspondence of two addresses—e.g., a virtual address and a physical address—of different respective address spaces. IOMMU 150 provides functionality to determine, based on page tables 148, a physical address with which DMA engine 158 is to access DMA buffer 141 on behalf of device 160.

To facilitate efficient use of memory management resources such as those of MMU 116 and/or those of IOMMU 150, some embodiments variously provide a circuit resource which detects a relationship between addresses which are each associated with (e.g., which are each within) a same set of addresses such as a same address range. Based on such a detected relationship, the circuit resource provides one of the related addresses for address translation with a memory management unit such as MMU 116 or IOMMU 150. However, based on the detected relationship, one or more others of the related addresses are instead provided by the circuit resource to a repository-referred to herein as a “sequestration resource”—in lieu of the memory management unit. In an embodiment, the one or more other related addresses are subsequently retrieved from the sequestration resource, wherein the retrieval is based on an indication that the memory management unit has completed a translation of the one of the related addresses. The retrieved one or more related addresses are then translated based on information which is determined from the translation completed by the memory management unit. In facilitating such sequestration of addresses, some embodiments variously eliminate or otherwise mitigate use of a memory management unit for one or more address translations which would otherwise be similar to another address translation which is completed with the memory management unit.

In the example embodiment shown, system 100 further comprises a filter unit 170 which is coupled (for example) to IOMMU 150, and which is further coupled to device 160 and memory controller 130 (via fabric 133). Filter unit 170 provides functionality to maintain a registry of those one or more filters (if any) which are currently enabled to be applied for determining whether an address of a given memory access request is to be provided to IOMMU 150 or (alternatively) whether said address is to be sequestered for later translation based on the translation of a different address by IOMMU 150. In an embodiment, a given filter is defined in the registry with information which specifies or otherwise indicates a set of one or more addresses (or “address set” herein) to which the filter in question corresponds. An address set comprises, for example, a contiguous range of addresses in an address space. Alternatively or in addition, an address set comprises a given two addresses, wherein one or more other addresses which are between said two addresses are not in the address space. In some embodiments, an address set corresponds to a particular one or more banks in memory.

For example, filter unit 170 registers a given filter based on an evaluation which determines that an address to be translated is not within an address set to which any currently enabled filter in the registry corresponds. Such an address is referred to herein as a “precedent address” (or “parent address”). While the registered filter is enabled, the address set to which the filter corresponds (i.e., an address set which includes a respective precedent address) is used as a basis for evaluating one or more other addresses to be translated. For example, where filter unit 170 determines that an address to be translated is within an address set to which some currently enabled filter corresponds, filter unit 170 directs such an address to a sequestration resource, rather than to IOMMU 150. Such an address is referred to herein as a “subsequent address” (or “child address”). Where filter unit 170 determines that IOMMU 150 has completed a translation of a precedent address (or a “precedent translation” herein), filter unit 170 performs operations to translate any subsequent addresses which have been sequestered, and which correspond to that precedent address. In one such embodiment, filter unit 170 performs operations to delete or otherwise disable a registered filter which corresponds to (e.g., which identifies) the address set which comprises the precedent address in question.

In some embodiments, system 100 additionally or alternatively provides filter functionality with a filter unit 180 of processor 110. In one such embodiment, filter unit 180 provides functionality to maintain a registry of one or more filters (if any) which are currently enabled to be applied for determining whether an address of a given memory access request is to be sequestered for later translation, or provided to MMU 116. For example, filter unit 180 registers a given filter based on a determination that an address to be translated is a precedent address. Furthermore, where it is determined that an address to be translated is a subsequent address, filter unit 180 directs such an address to a sequestration resource, rather than to MMU 116. Where it is determined that MMU 116 has completed a precedent translation, filter unit 180 performs operations to translate any sequestered subsequent addresses which correspond to that precedent address. In one such embodiment, filter unit 180 further performs operations to delete or otherwise disable a registered filter which corresponds to an address set which comprises the precedent address.

In an illustrative embodiment, filter unit 170 provides addresses to IOMMU 150 during operation of system 100, wherein a given one such address comprises (for example) a page number portion and an offset portion. In response to determining that translation information for the page number portion of a first address is not present in IOTLB 156, page walk circuitry 154 performs a page walk operation. More particularly, page walk circuitry 154 accesses translation information available in page tables 148 to determine a translation corresponding to the page number portion of the first address. The translation information obtained from page tables 148 indicates (for example) that a particular set of addresses each of a given virtual page corresponds to a particular set of addresses each of a given physical page. For example, such translation information indicates that a given one or more contiguous (or other) virtual pages correspond to a particular one or more contiguous (or other) physical pages.

Based on the translation information obtained from page tables 148, IOMMU 150 generates an entry within IOTLB 156 that specifies or otherwise indicates a correspondence of a particular one virtual page to a particular one physical page—e.g., wherein said entry of IOTLB 156 identifies a correspondence of a given range of contiguous virtual page numbers to a particular range of contiguous physical page numbers. Thus, the generated entry of IOTLB 156 represents translation information for multiple addresses (e.g., rather than merely for the first address) which, for example, each have a respective page number which is in a set of one or more page numbers. In various embodiments, IOMMU 150 provides to filter unit 170 translation information which specifies or otherwise indicates some or all of the information of the generated entry of IOTLB 156. In one such embodiment, the translation information comprises the translated version of the first address and/or otherwise indicates a portion of the translated version—e.g., a physical page number—to enable filter unit 170 to translate one or more other translations (if any) which were sequestered by filter unit 170 based on a filter which corresponds to a portion (such as a virtual page number) of the first address.

By way of illustration and not limitation, filter unit 170 provides to IOMMU 150 a first address based on a determination that the first address is a precedent address for which no corresponding filter was registered when an evaluation of the first address commenced. The first address is a virtual address which comprises a page number portion occupying bits [31:12] and an offset portion occupying bits [11:0]. In an illustrative scenario according to one embodiment, the page number portion of the first address is equal to 0×10001, and the offset portion is equal to 0×234. In one such embodiment, filter unit 170 registers a filter for a set of addresses (e.g., a range of consecutive addresses) which includes the first address—i.e., in addition to sending the first address for translation by IOMMU 150. For example, the set of addresses—for which sequestration is to be performed according to the filter—comprises addresses which each comprise a respective page number portion which is equal to 0×10001. In the example scenario, the set of addresses comprises any address which has a respective page number portion which is in a range of page number values (e.g., the range of values 0×10000-0×10007).

In one example scenario, page walk circuitry 154 accesses page tables 148 in response to a miss of IOTLB 156, and determines that a contiguous range of virtual page numbers extending from 0×10000 through 0×10007 corresponds to a contiguous range of physical page numbers extending from 0×20000 through 0×20007. Based on this determination, IOMMU 150 generates an entry within IOTLB 156 which identifies the correspondence of the range of virtual page numbers 0×10000 through 0×10007 to the range of physical page numbers 0×20000 through 0×20007.

During the pendency of the translation of the first address by IOMMU 150, filter unit 170 identifies a second address having (for example) a page number portion equal to 0×10005 and an offset portion equal to 0×222. Based on the page number portion thereof, the second address is identified by filter unit 170 as being a subsequent address, with respect to the filter which was registered based on the first address. As a result, the second address is sequestered for later translation by filter unit 170, rather than being sent to IOMMU 150.

After completing the translation of the first address, IOMMU 150 sends translation information which specifies or otherwise indicates to filter unit 170 the correspondence of the range of virtual page numbers 0×10000 through 0×10007 to the range of physical page numbers 0×20000 through 0×20007. Based on such translation information, filter unit 170 retrieves the second address from a sequestration repository, and translates the second address-e.g., by translating the virtual page number portion thereof to a physical page number portion which is equal to 0×20005.

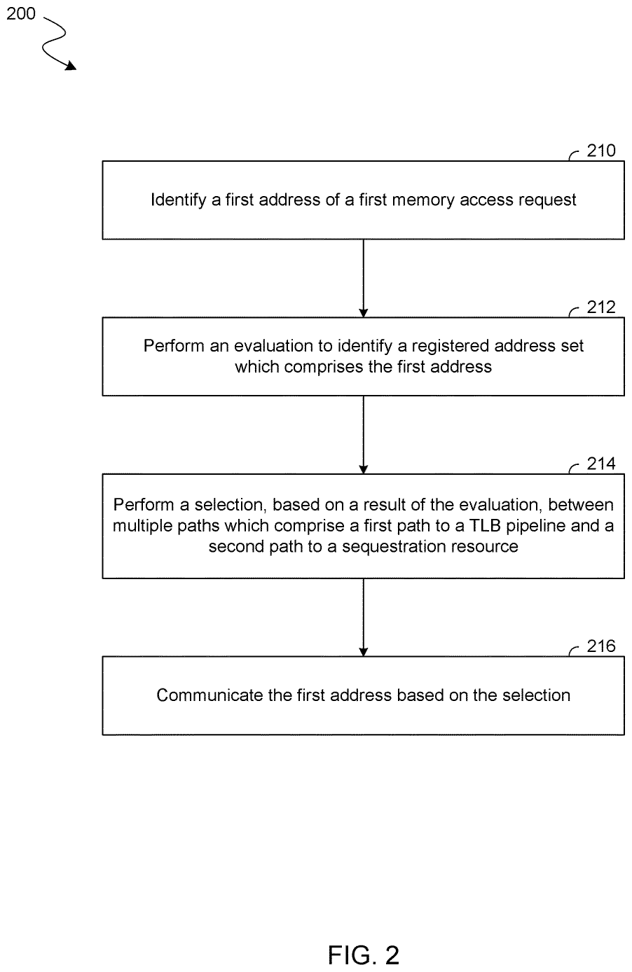

FIG. 2 illustrates features of a method 200 for performing an address translation according to an embodiment. Method 200 illustrates an embodiment wherein an address is selectively directed to one of a TLB pipeline, or a sequestration resource, where such direction is based on whether the address in question is in the same address range as another address, which was provided to the TLB pipeline. Operations such as those of method 200 are performed, for example, with hardware, firmware, and/or executing software such as that of system 100.

As shown in FIG. 2, method 200 comprises (at 210) identifying a first address of a first memory access request. Method 200 further comprises (at 212) performing an evaluation to identify a registered address set which comprises the first address. For example, the evaluation performed at 212 determines whether any currently enabled filter corresponds to a respective address set which comprises the first address. In an embodiment, a virtual page number portion of the first address is a basis for the evaluation performed at 212.

Method 200 further comprises (at 214) performing a selection between multiple paths based on a result of the evaluation at 212. In one such embodiment, the multiple paths comprise a first path to a pipeline which performs address translations with a TLB. For example, the pipeline is a circuit resource of a memory management unit such as MMU 116 or IOMMU 150. Furthermore, the multiple paths comprise a second path to a sequestration resource which is to be a repository of any subsequent addresses which correspond each to a respective enabled filter. Based on the selection performed at 214, method 200 (at 216) communicates the first address to one of the TLB pipeline or the sequestration resource.

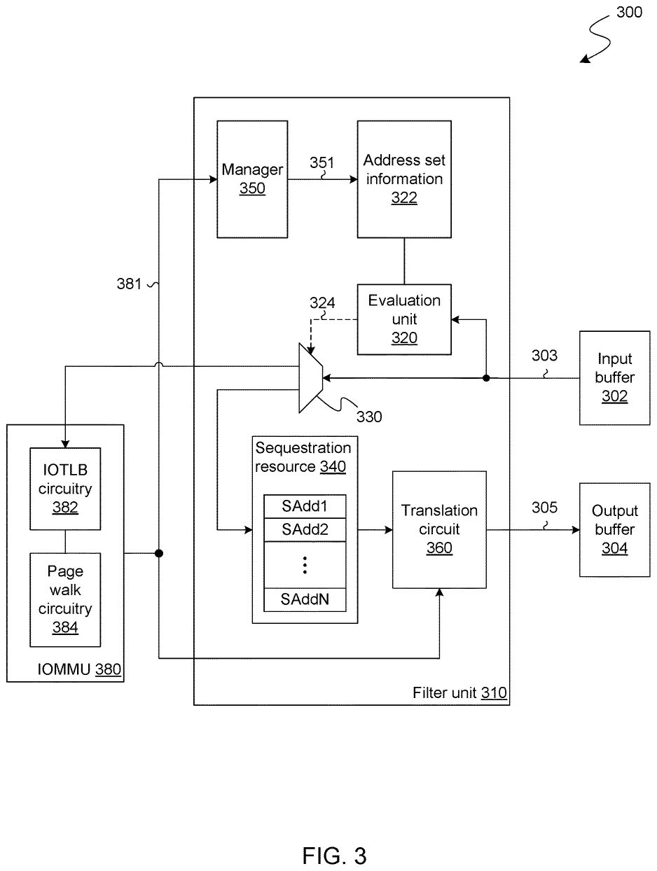

FIG. 3 illustrates features of a device 300 for supporting the translation of addresses according to an embodiment. Device 300 illustrates one example of an embodiment which sequesters one or more subsequent addresses outside of a memory management unit, pending the translation of a corresponding precedent address. In some embodiments, device 300 includes features of filter unit 170, filter unit 180, and/or other resources of system 100—e.g., wherein operations of method 200 are performed with some or all of device 300.

As shown in FIG. 3, device 300 comprises a filter unit 310 and a memory management unit-in this case, an input/output memory management unit (IOMMU) 380 which is coupled thereto. For example, filter unit 310 and IOMMU 380 correspond functionally to filter unit 170 and IOMMU 150 (or alternatively, to filter unit 180 and MMU 116), respectively. Address translation functionality of IOMMU 380 is provided with input-output translation lookaside buffer (IOTLB) circuitry 382 and page walk circuitry 384 which is coupled thereto. In the embodiment shown, filter unit 310 is coupled to one or more buffers which serve as repositories for addresses which each correspond to a respective memory access request. For example, device 300 comprises an input buffer 302 for yet-to-be-translated addresses, and an output buffer 304 for addresses which have been translated with filter unit 310 and/or IOMMU 380. In other embodiments, device 300 omits input buffer 302, output buffer 304 and/or IOMMU 380—e.g., wherein said embodiments are implemented entirely with some or all of filter unit 310.

In the example embodiment shown, circuit resources of filter unit 310 comprise an evaluation unit 320, selection circuitry 330, a sequestration resource 340, a manager 350, and a translation circuit 360. Evaluation unit 320 is coupled to successively receive addresses 303 from input buffer 302—e.g., wherein addresses 303 are received one at a time according to an order in which corresponding memory access requests are buffered. Evaluation unit 320 comprises circuitry which is configured to perform an evaluation, based on a given one of addresses 303, to determine whether filter unit 310 is currently enforcing a filter for an address set that comprises the given address 303.

Based on the result of such an evaluation, the given address 303 is selectively directed either to IOMMU 380 or to sequestration resource 340. For example, filter unit 310 forwards a given address 303 for translation by IOMMU 380 where it is determined that no applicable filter currently corresponds to the given address 303 (e.g., wherein filter unit further registers an applicable filter based on such a determination). By contrast, filter unit 310 instead sequesters a given address 303 for subsequent processing where it is determined that some applicable filter currently corresponds to the given address 303.

By way of illustration and not limitation, evaluation unit 320 is coupled to, or alternatively comprises, a repository of address set information 322. Such a repository stores data identifying one or more address sets (if any) that are currently registered each as a respective basis for determining whether address sequestration is to be performed. For example, address set information 322 specifies or otherwise indicates those address sets, if any, for which corresponding filters are currently active. Accordingly address set information 322 is available as a reference for evaluation unit 320 to determine whether a given address belongs to an address set that is presently subject to filtering operations.

Address set information 322 is maintained in an up-to-date state with manager 350 and/or evaluation unit 320, for example. In an embodiment, maintenance of address set information 322 comprises registering an identifier of an address set that comprises an address which has been identified by filter unit 310 as being a precedent address. For example, evaluation unit 320 (or another suitable resource of filter unit 310) registers such an address set identifier in address set information 322, which thereby facilitates a creation, activation, or other enablement of a filter corresponding to the address set in question.

Alternatively or in addition, maintenance of address set information 322 comprises removal of an identifier associated with a registered address set. For example, manager 350 (or another suitable resource of filter unit 310) accesses address set information 322 to remove an identifier of a registered address set, or to otherwise disable a filter corresponding thereto. Accordingly, address set information 322 is dynamically updated as filters are variously created, modified, disabled, removed, or the like.

In various embodiments, evaluation unit 320 performs a lookup, search, or other access of address set information 322, based on a given address 303, to determine the presence or absence of a corresponding registered address set. Evaluation unit 320 provides functionality to detect a condition (referred to herein as a “precedent condition”) wherein a given address 303 is received or otherwise identified at filter unit 310 at a time when no currently enabled filter corresponds to an address set that comprises that given address 303. In various embodiments, identification of a precedent condition indicates to filter unit 310 that an address set comprising the given address 303 is to be identified and registered as a basis for conditionally filtering subsequent addresses. For example, evaluation unit 320 identifies and registers a range of addresses (or other suitable address set) which correspond to a particular number of one or more memory pages. The precedent condition further indicates to evaluation unit 320 that the precedent address 303 is to be provided to IOMMU 380 for translation (i.e., as opposed to the precedent address 303 being sequestered). For example, based on the precedent condition, a control signal 324 generated by evaluation unit 320 operates selection circuitry 330 (such as a demultiplexer circuit) to direct such a precedent address 303 to IOMMU 380.

In some embodiments, detection of a precedent condition further indicates that translation of a precedent address is to be monitored and tracked. For example, manager 350 (or another suitable resource of device 300) monitors the progress and completion status of translation operations by IOMMU 380. Such monitoring facilitates a later determination as to whether, and when, a filter corresponding to the associated address set is to be deleted or otherwise disabled.

Evaluation unit 320 further provides functionality to detect a condition (referred to herein as a “relation condition”) wherein a received address—e.g., received by filter unit 310—is in a currently registered address set for a corresponding, previously received precedent address. By way of illustration and not limitation, evaluation unit 320 subsequently receives another address 303 from input buffer 302 after identification of a precedent address and registration of a corresponding address set. Evaluation unit 320 performs an evaluation, based on address set information 322 and the subsequently received other address 303, to determine whether a relation condition exists. Detection of the relation condition indicates to filter unit 310 that the identified subsequent address 303 is to be sequestered. In one such embodiment, the control signal 324 generated by evaluation unit 320 operates selection circuitry 330, based on the detection of a relation condition, to direct the subsequent address 303 to sequestration resource 340 (e.g., in lieu of the subsequent address 303 being directed to IOMMU 380). Sequestration resource 340 functions as a temporary repository for subsequent addresses which each await the respective translation of a corresponding precedent translation.

Although some embodiments are not limited in this regard, evaluation unit 320—or another suitable circuit resource of filter unit 310—further provides functionality to detect a condition (referred to herein as an “exception condition”) wherein sequestering of a subsequent address is to be disabled or otherwise prevented. By way of illustration and not limitation, an exception condition is indicated where sequestration resource 340 reaches a threshold maximum number of sequestered addresses. In one such embodiment, evaluation unit 320 generates control signal 324 to operate selection circuitry 330, responsive to the detection of such an exception condition, to route such a subsequent address to IOMMU 380. Accordingly, filter unit 310 supports selective bypass of sequestration mechanisms, where one or more predetermined operational criteria are satisfied.

In various embodiments, manager 350 and translation circuit 360 variously provide functionality to detect a condition (referred to herein as a “translation condition”) wherein a precedent translation—i.e., a translation of a precedent address—has been completed by IOTLB circuitry 382 or by page walk circuitry 384, for example. In the embodiment shown, a translation condition is detected by manager 350 based on a signal 381 from IOMMU 380, wherein signal 381 identifies a translated address corresponding to a previously-identified precedent address. In various embodiments, signal 381 comprises translated address information, completion status information, identifier information, and/or any of various other types of information which are suitable to facilitate identification of a registered address set (if any) which corresponds to the translated precedent address.

Based on signal 381, manager 350 accesses address set information 322 to delete, or otherwise disable a filter (if any) which corresponds to the translated precedent address. For example, a signal 351 from manager 350 is communicated to remove from address set information 322 an identifier of an address set that comprises the original untranslated precedent address. Removal of the identifier prevents continued sequestration of addresses which are in that address set—e.g., at least until the creation of another filter for the same address set.

In one embodiment, translation circuit 360 further operates based on signal 381, or another suitable signal received from IOMMU 380, to identify currently sequestered addresses (if any) which are associated with the same address set as the translated precedent address. For example, translation circuit 360 searches among various sequestered subsequent addresses SAdd1, SAdd2, . . . , SAddN which are currently stored in sequestration resource 340. The search determines which, if any, of the sequestered addresses belong to the address set corresponding to the translated precedent address.

Translation circuit 360 is operable to selectively retrieve sequestered addresses from sequestration resource 340, which are then translated by translation circuit 360 each based on respective translation information associated with a corresponding precedent address. In an embodiment, translation circuit 360 derives translated addresses for the sequestered subsequent addresses without requiring additional TLB searching, or additional page walk operations for each such address. The translated precedent address and any corresponding translated subsequent addresses are then provided by translation circuit 360 as translated addresses 305 to output buffer 304. Output buffer 304 stores translated addresses for subsequent use each in a different respective memory access request.

In various embodiments, translation circuit 360 determines a relative prioritization of multiple sequestered addresses with respect to each other, wherein the multiple addresses are each of the same registered address set. For example, translation circuit 360 includes or is coupled to receive or otherwise access reference information which identifies an order of said multiple addresses relative to each other. In one such embodiment, the relative prioritization determines at least in part a relative order according to which translation circuit 360 is to variously retrieve individual ones of said multiple addresses from sequestration resource 340, translate individual ones of said multiple sequestered addresses, and/or provide translated addresses to output buffer 304. By way of illustration and not limitation, sequestered addresses in a given registered address set are prioritized for retrieval, translation and/or communication according to a relative order in which the sequestered addresses were received by filter unit 310.

In various embodiments, translation circuit 360 includes or otherwise has access to one or more programmable hash control registers and/or any of various other circuit resources (not shown) which are suitable to facilitate the directing of memory access requests according to any of various partitioning schemes. In one such embodiment, one or more programmable hash control registers provide configuration state information which specifies or otherwise indicates to translation circuit 360 that (for example) a particular one or more address bits and/or a particular one or more requester stream identifier bits of a memory access request are to be a basis for identifying a particular location in memory as corresponding to a particular type of memory access request.

For example, in some embodiments, address set information 322 is implemented with any of various suitable data portions (e.g., multiple banks), wherein evaluation unit 320 performs respective hashing calculations based on an address 303 to efficiently access only one such data portion to identify a corresponding filter (if any) which is currently registered. In one such embodiment, manager 350 additionally or alternatively performs respective hashing calculations based on address information in signal 381 to efficiently access only one such data portion to identify a corresponding filter which is to be deleted.

In various embodiments, sequestration resource 340 is additionally or alternatively implemented with any of various suitable data portions (e.g., banks), wherein evaluation unit 320 performs respective hashing calculations based on an address 303 to efficiently access only one such data portion to identify a location for sequestering said address 303. In one such embodiment, translation circuit 360 additionally or alternatively performs respective hashing calculations based on address information in signal 381 to efficiently access only one such data portion to identify a corresponding location from which one or more sequestered addresses are to be retrieved for translation.

In some embodiments, manager 350—or another suitable circuit resource of filter unit 310—provides functionality to detect a condition (referred to herein as a “termination condition”) wherein a given filter is to be deleted or otherwise disabled. For example, detection of a termination condition is based on an invalidation signal which indicates that at least some translation information is no longer reliable. By way of illustration and not limitation, an agent executing in software directly or indirectly signals manager 350 (for example) that one or more cached translations maintained with IOTLB circuitry 382 are invalid, are being flushed, or the like. Responsive to such signaling, manager 350 identifies one or more corresponding filters and removes or disables them within address set information 322. In some embodiments, an invalidation signal additionally or alternatively results in filter unit 310 delaying a communication of one or more handshake signals which are to be based on the invalidation signal (e.g., wherein the one or more handshake signals confirm a completion of a TLB flush and/or other management operations). For example, filter unit 310 delays such handshake communication(s) until after one or more addresses have been retrieved from the sequestration resource 340 (and, in some embodiments, until after the one or more retrieved addresses have been translated).

Alternatively or in addition, a termination condition is indicated where sequestration resource 340 reaches a threshold maximum number of sequestered addresses. In one such embodiment, manager 350 determines based on a termination condition that one or more filters are to be deleted or otherwise disabled—e.g., at least until translation circuit 360 processes a sufficient number of sequestered addresses.

In some embodiments, detection of a termination condition additionally or alternatively comprises evaluation unit 320, manager 350 or another suitable resource of filter unit 310 determining that address set information 322 has reached a threshold maximum amount of available memory. By way of illustration and not limitation, evaluation unit 320 determines that the creation of a new filter is to be prioritized over the retention of an older filter which is represented in address set information 322.

In various embodiments, detection of a termination condition is additionally or alternatively based on a counter resource (not shown) that tracks an elapsed time, a number of received addresses associated with a particular filter, or the like. In one such embodiment, the associated filter is deleted or otherwise disabled based on a determination that the counter has reached a threshold value. By way of illustration and not limitation, a termination condition is indicated where it is determined—e.g., by evaluation unit 320—that a sequence of received addresses 303 exhibits a break in a succession of addresses that belong to the same address set. Responsive to detection of such a break, filter unit 310 determines that continued maintenance of the corresponding filter is no longer warranted, whereupon filter unit 310 accesses address set information 322 to remove the corresponding filter.

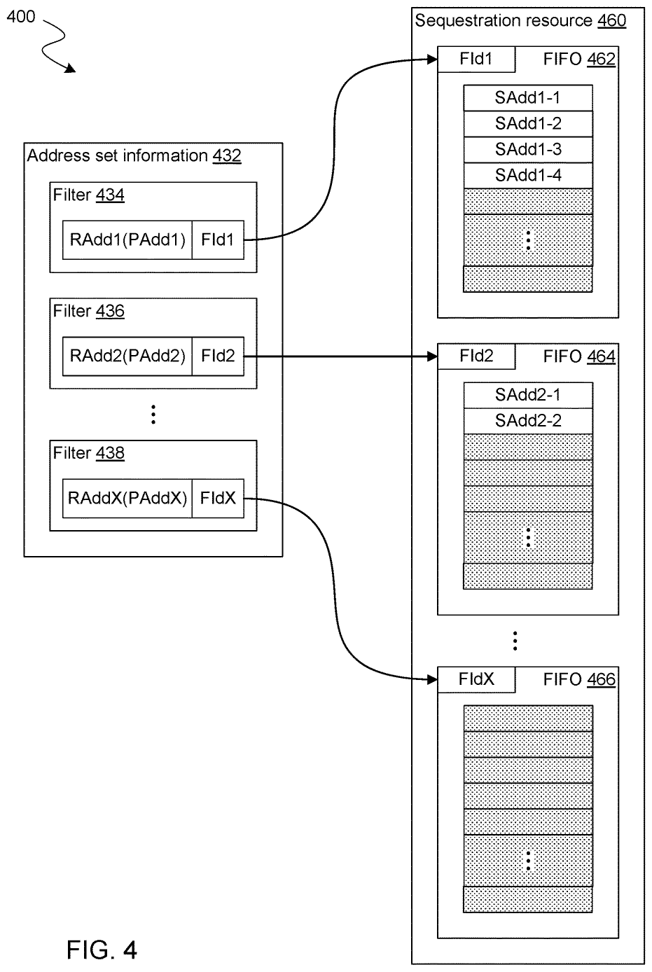

FIG. 4 illustrates features of a device 400 for accessing information which facilitates address translation according to an embodiment. In an embodiment, device 400 is used by circuit resources such as those of system 100 or device 300—e.g., wherein operations of method 200 are based on reference information which is maintained at device 400.

As shown, device 400 comprises address set information 432 and a sequestration resource 460 which, for example, provide functionality corresponding to that of address set information 322 and translation circuit 360, respectively. In an embodiment, address set information 432 and sequestration resource 460 cooperate with one or more circuit resources of device 400 to facilitate the selective sequestration and subsequent processing of a given address based on the registration of a corresponding address set. In an embodiment, address set information 432 is made available to a circuit resource (such as evaluation unit 320, for example) as a reference for determining whether a given address is to be directed to sequestration resource 460 or, alternatively, to a memory management unit (MMU), such as MMU 116 or IOMMU 150. For example, when a received address is evaluated, address set information 432 provides data that enables a determination as to whether the address corresponds to a registered address set (if any) for which sequestration is to be performed. Based on such a determination, the address is selectively routed either to sequestration resource 460 or to the MMU.

At a given time during operation of device 400, address set information 432 defines one or more filters, wherein each filter corresponds to a different respective address set. For a given filter, address set information 432 provides an identifier of the corresponding address set to facilitate the selective sequestering of an address which is determined to be within that address set. In the example embodiment shown, address set information 432 defines filters 434, 436, . . . , 438. However, the particular number of filters defined in address set information 432, as well as the particular address sets corresponding thereto, are merely illustrative of one example scenario according to an embodiment.

In an embodiment, filter 434 is defined in address set information 432 with an identifier of a range of addresses RAdd1 which correspond to (e.g., which comprises) a respective precedent address PAdd1. Furthermore, filter 436 is similarly defined in address set information 432 with an identifier of a range of addresses RAdd2 which correspond to a respective precedent address PAdd2. Further still, filter 438 is defined in address set information 432 with an identifier of a range of addresses RAddX which correspond to a respective precedent address PAddX. In various embodiments, a given one of precedent addresses PAdd1, PAdd2, . . . , PAddX serves as a basis for identifying a corresponding address set, for which subsequent addresses are to be temporarily sequestered pending occurrence of a corresponding translation event.

Although some embodiments are not limited in this regard, sequestration resource 460 is operated (e.g., by evaluation unit 320, manager 350, or another suitable circuit resource) to provide one or more buffers that each correspond to a different respective address set. A given one such buffer (or other suitable data structure) is used for sequestering subsequent addresses that are each within the corresponding address set. In one embodiment, sequestered addresses (if any) within a given buffer are read out from sequestration resource 460 by a circuit resource such as translation circuit 360. For example, such readout is performed in response to detection of a corresponding precedent translation, wherein one or more sequestered subsequent addresses are each translated based on translation information determined from a corresponding precedent translation.

By way of illustration and not limitation, device 400 maintains within sequestration resource 460 a FIFO buffer 462 which corresponds to (and, for example, identifies) the range of addresses RAdd1 that had previously been registered based on detection of precedent address PAdd1. Furthermore, device 400 similarly maintains within sequestration resource 460 a FIFO buffer 464 which corresponds to the range of addresses RAdd2 that had previously been registered based on detection of precedent address PAdd2. Further still, device 400 similarly maintains within sequestration resource 460 a FIFO buffer 466 which corresponds to the range of addresses RAddX that had previously been registered based on detection of precedent address PAddX. However, the particular number of FIFO buffers in sequestration resource 460 is merely illustrative of one example scenario according to an embodiment.

In various embodiments, filters 434, 436, . . . , 438 variously comprise—or are otherwise associated with—respective filter identifiers FId1, FId2, . . . , FIdX. In one embodiment, filter identifiers FId1, FId2, . . . , FIdX are referenced as a basis for sequestering a given subsequent address to a corresponding one of FIFO buffers 462, 464, and 466. In the example scenario shown, FIFO buffer 462 sequesters—at a given time during operation of device 400—subsequent addresses SAddr1-1, SAddr1-2, SAddr1-3, and SAddr1-4 which are each within the range of addresses RAdd1 that has been registered with filter 434. Furthermore, FIFO buffer 464 similarly sequesters subsequent addresses SAddr2-1 and SAddr2-2 which are each within the range of addresses RAdd2 that has been registered with filter 436. In one such embodiment, FIFO buffer 466 does not yet sequester any subsequent addresses within the range of addresses RAddX that has been registered with filter 438.

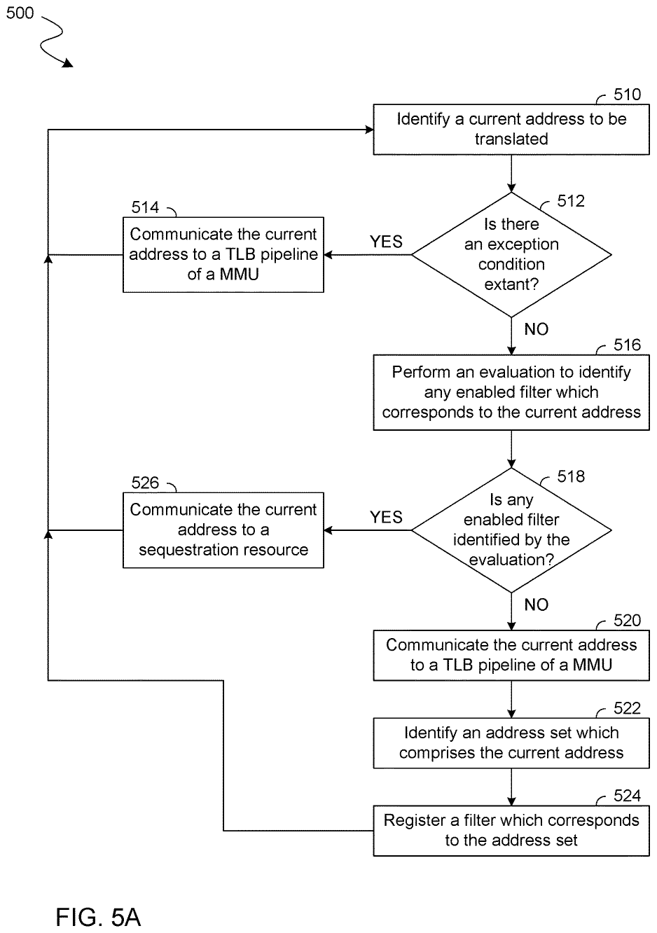

FIG. 5A illustrates features of a method 500 for determining a processing by which an address is to be translated according to an embodiment. Method 500 illustrates one example of an embodiment wherein the pendency of a translation of a precedent address is used as a basis for sequestering a subsequent address for later translation. In some embodiments, operations of method 500 are performed with resources of system 100 or device 300—e.g., wherein method 500 includes operations of method 200.

As shown in FIG. 5A, method 500 comprises (at 510) identifying a current address which is to be translated. Method 500 further comprises performing an evaluation (at 512) to determine whether any exception condition is currently extant. Where it is determined at 512 that there is an extant exception condition, method 500 (at 514) communicates the current address to a TLB pipeline of an MMU. After the communicating at 514, method 500 performs a next instance of the identifying at 510.

Where it is instead determined at 512 that no exception condition is currently extant, method 500 (at 516) performs an evaluation to identify whether any enabled filter corresponds to the current address—e.g., wherein any such filter specifies or otherwise indicates an address set which comprises the current address. Method 500 further comprises determining (at 518) whether or not a failure of the most recent evaluation at 516 is indicated—e.g., comprising determining whether any currently enabled filter has been identified as corresponding to the current address. Where it is determined at 518 that a currently enabled filter has been identified, method 500 (at 526) communicates the current address to a sequestration resource. After the communicating at 526, method 500 performs a next instance of the identifying at 510.

Where it is instead determined at 518 that no currently enabled filter has been identified, method 500 (at 520) communicates the current address to a TLB pipeline of an MMU. Furthermore, method 500 (at 522) identifies an address set which comprises the current address. Further still, method 500 (at 524) registers a filter which corresponds to the address set most recently identified at 522. After the registering at 524, method 500 performs a next instance of the identifying at 510.

FIG. 5B illustrates features of a method 550 for performing address translation and address filter management according to an embodiment. In some embodiments, operations of method 550 are performed with resources of system 100 or device 300—e.g., wherein method 550 includes or is otherwise based on operations of method 200.

As shown in FIG. 5B, method 550 comprises performing an evaluation (at 560) to determine whether—at least since a most recent instance of the evaluating at 560—an MMU has performed a translation of a precedent address. Where it is determined at 560 that no precedent translation is indicated, method 550 repeats the evaluating at 560 until a precedent translation is detected.

Where it is instead determined at 560 that a precedent translation has been performed, method 550 (at 562) identifies translation information which is based on the precedent translation. Furthermore, method 550 (at 564) retrieves from a sequestration resource a subsequent address (if any) which corresponds to the translated precedent address. Method 550 further comprises (at 566) translating the retrieved subsequent address based on the translation information which was most recently identified at 562. Method 550 further comprises (at 568) deregistering a filter which corresponds to the precedent address and the subsequent address. After the deregistering at 568, method 550 performs a next instance of the evaluating at 560.

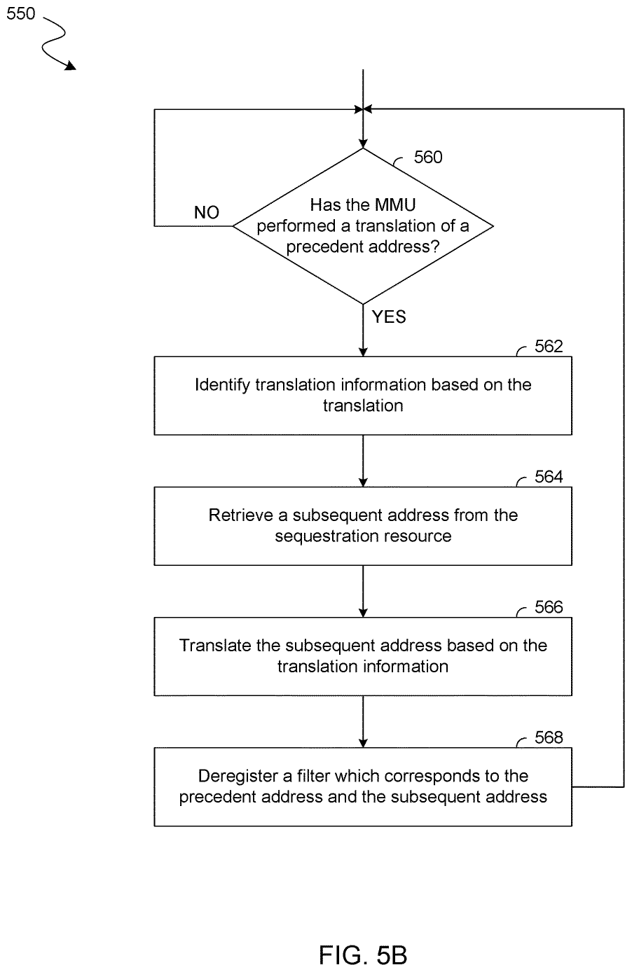

FIG. 6 illustrates features of a device 600 for supporting in-parallel evaluation of addresses to be translated according to an embodiment. Device 600 illustrates one example of an embodiment wherein multiple filter circuits are coupled in parallel with each other, wherein each such filter circuit is operable to selectively direct a respective address to either of a memory management unit or a sequestration resource. In some embodiments, device 600 has features of system 100 or device 300—e.g., wherein operations of method 200 or method 500 are performed with some or all of device 600.

As shown, device 600 comprises a filter unit 610 and an IOMMU 680 which is coupled thereto. In an embodiment, filter unit 610 and IOMMU 680 provide functionality corresponding to that of filter unit 310 and IOMMU 380 (respectively). In the example embodiment shown, IOMMU 680 comprises IOTLB circuitry 684 and page walk circuitry 686 which, in some embodiments, correspond functionally to IOTLB circuitry 382 and page walk circuitry 384 (respectively). For example, IOTLB circuitry 684 performs cached address translation operations, while page walk circuitry 686 performs page table traversal operations where a TLB search, by IOTLB circuitry 684, results in a cache miss.

In an embodiment, filter unit 610 comprises a sequestration resource 640, a manager 650, and a translation circuit 660 which, for example, provide functionality corresponding to that of sequestration resource 340, manager 350, and translation circuit 360 (respectively). In some embodiments, filter unit 610 is further coupled to an input buffer 602 and an output buffer 604 (e.g., corresponding functionally to input buffer 302 and output buffer 304, respectively). In other embodiments, device 600 omits input buffer 602, output buffer 604, and/or IOMMU 680—e.g., wherein such embodiments are implemented entirely with some or all of the functionality of filter unit 610.

In the example embodiment shown, filter unit 610 comprises a plurality of filter circuits (e.g., including the illustrative filter circuits 612, 614, 616, 618 shown) which are coupled, in parallel with each other, between input buffer 602 and each of IOMMU 680 and sequestration resource 640. Such an arrangement facilitates concurrent evaluation of multiple addresses and supports parallel processing of address-filtering operations. In an embodiment, filter circuits 612, 614, 616, and 618 each provide respective functionality—such as that of evaluation unit 320, address set information 322, and selection circuitry 330—to selectively direct addresses to a particular one of IOMMU 680 and sequestration resource 640 based on reference information which identifies one or more address sets as corresponding each to a respective sequestration filter. By way of illustration and not limitation, filter circuit 612 comprises, or otherwise has access to, address set information 613 which, in an embodiment, includes features of address set information 322—e.g., wherein filter circuit 614 includes or otherwise has access to similar address set information 615. Alternatively or additionally, filter circuit 616 comprises, or otherwise has access to, address set information 617—e.g., wherein filter circuit 618 similarly has access to, address set information 619.

In one such embodiment, manager 650 communicates with filter circuits 612, 614, 616, 618 (e.g., via the signal 651 shown) to keep up-to-date some or all of address set information 613, address set information 615, address set information 617, and address set information 619. For example, manager 650 synchronizes filter-related information among the various filter circuits 612, 614, 616, 618 to maintain consistency of filtering operations across filter unit 610.

In an illustrative scenario according to one embodiment, filter circuits 612, 614, 616, and 618 are each coupled to receive respective ones of addresses 603 provided by input buffer 602. Filter circuits 612, 614, 616, 618 variously perform operations each to evaluate a respective one of addresses 603 based on a corresponding one of address set information 613, address set information 615, address set information 617, and address set information 619. Such evaluation is to determine, for example, whether the respective addresses 603 is a precedent address for which there is no currently enabled filter and/or whether the respective addresses 603 is a subsequent address which corresponds to a currently enabled filter. Based on such evaluations, precedent addresses are variously directed each from a respective one of filter circuits 612, 614, 616, 618 to IOMMU 680—e.g., via a respective one of the signal paths 620 shown. Furthermore, subsequent addresses are variously directed, based on such evaluations, each from a respective one of filter circuits 612, 614, 616, 618 to sequestration resource 640—e.g., via a respective one of the signal paths 622 shown.

Based on the translation of a given precedent address, IOMMU 680 generates and sends to manager 650 (and, in some embodiments, to translation circuit 660) a signal 681 which specifies or otherwise indicates a translated version of the precedent address that has been translated by IOMMU 680. Responsive to signal 681, manager 650 updates some or all of address set information 613, 615, 617, and 619—e.g., to delete or otherwise disable a filter which corresponds to the translated precedent address. In one such embodiment, translation circuit 660 accesses sequestration resource 640, responsive to signal 681, to retrieve and translate one or more subsequent addresses (if any) which are in the address set which corresponds to the filter. In an embodiment, the translated subsequent addresses generated by translation circuit 660 are provided as addresses 605 to output buffer 604. Output buffer 604 buffers addresses 605 for use each in a different respective memory access request.

### Exemplary Computer Architectures.

Detailed below are descriptions of exemplary computer architectures. Other system designs and configurations known in the arts for laptop, desktop, and handheld personal computers (PCs), personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

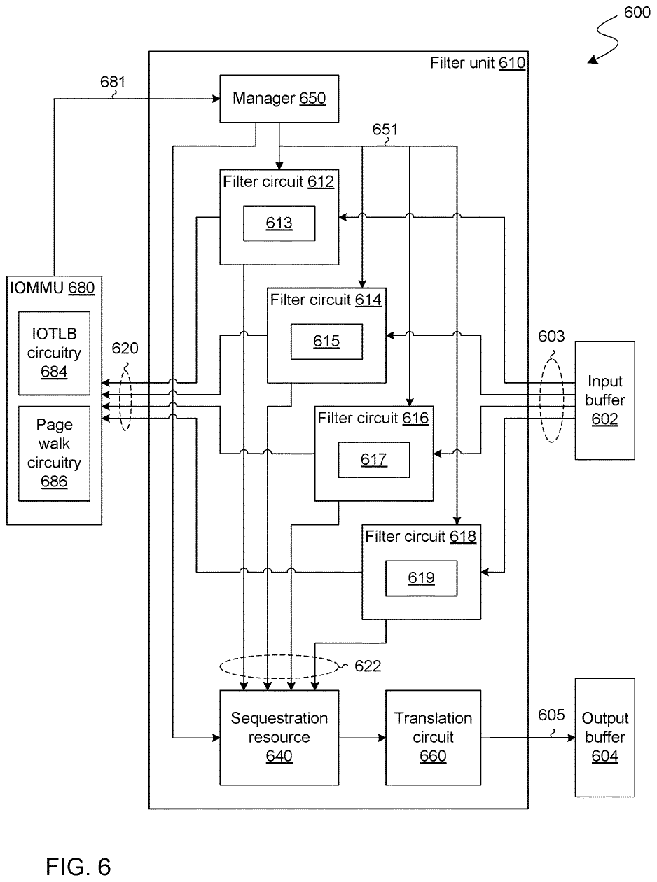

FIG. 7 illustrates an exemplary system. Multiprocessor system 700 is a point-to-point interconnect system and includes a plurality of processors including a first processor 770 and a second processor 780 coupled via a point-to-point interconnect 750. In some examples, the first processor 770 and the second processor 780 are homogeneous. In some examples, first processor 770 and the second processor 780 are heterogenous. Though the exemplary system 700 is shown to have two processors, the system may have three or more processors, or may be a single processor system.

Processors 770 and 780 are shown including integrated memory controller (IMC) circuitry 772 and 782, respectively. Processor 770 also includes as part of its interconnect controller point-to-point (P-P) interfaces 776 and 778; similarly, second processor 780 includes P-P interfaces 786 and 788. Processors 770, 780 may exchange information via the point-to-point (P-P) interconnect 750 using P-P interface circuits 778, 788. IMCs 772 and 782 couple the processors 770, 780 to respective memories, namely a memory 732 and a memory 734, which may be portions of main memory locally attached to the respective processors.

Processors 770, 780 may each exchange information with a chipset 790 via individual P-P interconnects 752, 754 using point to point interface circuits 776, 794, 786, 798. Chipset 790 may optionally exchange information with a coprocessor 738 via an interface 792. In some examples, the coprocessor 738 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 770, 780 or outside of both processors, yet connected with the processors via P-P interconnect, such that either or both processors'local cache information may be stored in the shared cache if a processor is placed into a low power mode.

Chipset 790 may be coupled to a first interconnect 716 via an interface 796. In some examples, first interconnect 716 may be a Peripheral Component Interconnect (PCI) interconnect, or an interconnect such as a PCI Express interconnect or another I/O interconnect. In some examples, one of the interconnects couples to a power control unit (PCU) 717, which may include circuitry, software, and/or firmware to perform power management operations with regard to the processors 770, 780 and/or co-processor 738. PCU 717 provides control information to a voltage regulator (not shown) to cause the voltage regulator to generate the appropriate regulated voltage. PCU 717 also provides control information to control the operating voltage generated. In various examples, PCU 717 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 717 is illustrated as being present as logic separate from the processor 770 and/or processor 780. In other cases, PCU 717 may execute on a given one or more of cores (not shown) of processor 770 or 780. In some cases, PCU 717 may be implemented as a microcontroller (dedicated or general-purpose) or other control logic configured to execute its own dedicated power management code, sometimes referred to as P-code. In yet other examples, power management operations to be performed by PCU 717 may be implemented externally to a processor, such as by way of a separate power management integrated circuit (PMIC) or another component external to the processor. In yet other examples, power management operations to be performed by PCU 717 may be implemented within BIOS or other system software.

Various I/O devices 714 may be coupled to first interconnect 716, along with a bus bridge 718 which couples first interconnect 716 to a second interconnect 720. In some examples, one or more additional processor(s) 715, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 716. In some examples, second interconnect 720 may be a low pin count (LPC) interconnect. Various devices may be coupled to second interconnect 720 including, for example, a keyboard and/or mouse 722, communication devices 727 and a storage circuitry 728. Storage circuitry 728 may be one or more non-transitory machine-readable storage media as described below, such as a disk drive or other mass storage device which may include instructions/code and data 730 in some examples. Further, an audio I/O 724 may be coupled to second interconnect 720. Note that other architectures than the point-to-point architecture described above are possible. For example, instead of the point-to-point architecture, a system such as multiprocessor system 700 may implement a multi-drop interconnect or other such architecture.

### Exemplary Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

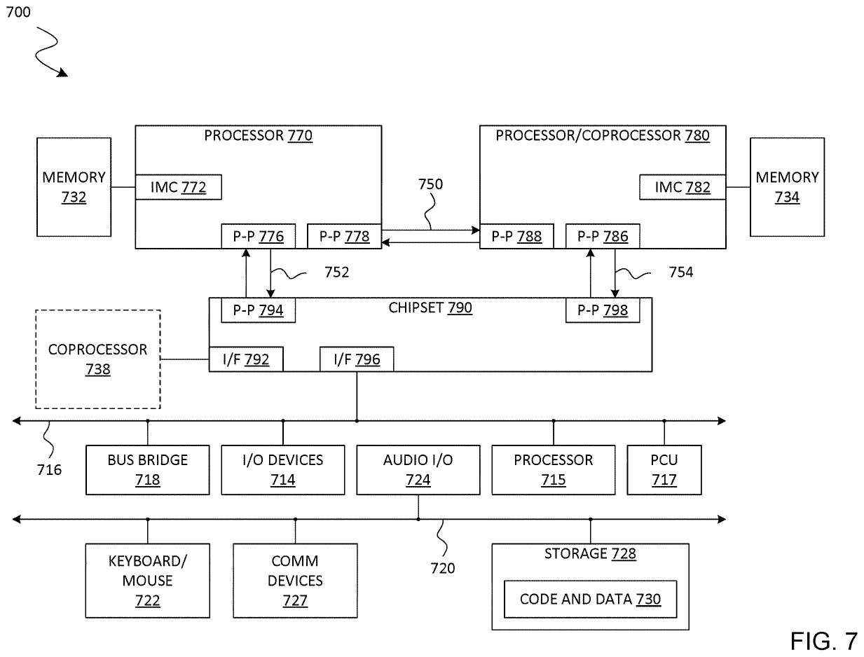

FIG. 8 illustrates a block diagram of an example processor 800 that may have more than one core and an integrated memory controller. The solid lined boxes illustrate a processor 800 with a single core 802A, a system agent unit circuitry 810, a set of one or more interconnect controller unit(s) circuitry 816, while the optional addition of the dashed lined boxes illustrates an alternative processor 800 with multiple cores 802A-802N, a set of one or more integrated memory controller unit(s) circuitry 814 in the system agent unit circuitry 810, and special purpose logic 808, as well as a set of one or more interconnect controller units circuitry 816. Note that the processor 800 may be one of the processors 770 or 780, or co-processor 738 or 715 of FIG. 7.

Thus, different implementations of the processor 800 may include: 1) a CPU with the special purpose logic 808 being integrated graphics and/or scientific (throughput) logic (which may include one or more cores, not shown), and the cores 802A-N being one or more general purpose cores (e.g., general purpose in-order cores, general purpose out-of-order cores, or a combination of the two); 2) a coprocessor with the cores 802A-N being a large number of special purpose cores intended primarily for graphics and/or scientific (throughput); and 3) a coprocessor with the cores 802A-N being a large number of general purpose in-order cores. Thus, the processor 800 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 800 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 804A-804N within the cores 802A-N, a set of one or more shared cache unit(s) circuitry 806, and external memory (not shown) coupled to the set of integrated memory controller unit(s) circuitry 814. The set of one or more shared cache unit(s) circuitry 806 may include one or more mid-level caches, such as level 2 (L2), level 3 (L3), level 4 (L4), or other levels of cache, such as a last level cache (LLC), and/or combinations thereof. While in some examples ring-based interconnect network circuitry 812 interconnects the special purpose logic 808 (e.g., integrated graphics logic), the set of shared cache unit(s) circuitry 806, and the system agent unit circuitry 810, alternative examples use any number of well-known techniques for interconnecting such units. In some examples, coherency is maintained between one or more of the shared cache unit(s) circuitry 806 and cores 802A-N.

In some examples, one or more of the cores 802A-N are capable of multi-threading. The system agent unit circuitry 810 includes those components coordinating and operating cores 802A-N. The system agent unit circuitry 810 may include, for example, power control unit (PCU) circuitry and/or display unit circuitry (not shown). The PCU may be or may include logic and components needed for regulating the power state of the cores 802A-N and/or the special purpose logic 808 (e.g., integrated graphics logic). The display unit circuitry is for driving one or more externally connected displays.

The cores 802A-N may be homogenous in terms of instruction set architecture (ISA). Alternatively, the cores 802A-N may be heterogeneous in terms of ISA; that is, a subset of the cores 802A-N may be capable of executing an ISA, while other cores may be capable of executing only a subset of that ISA or another ISA.

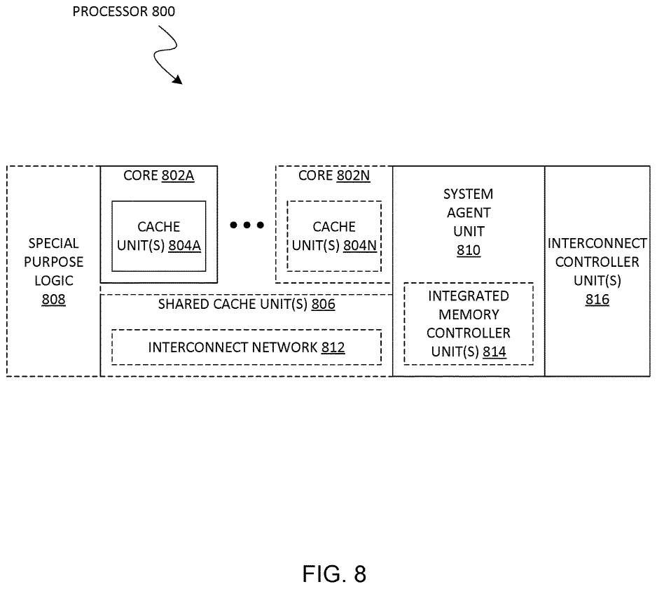

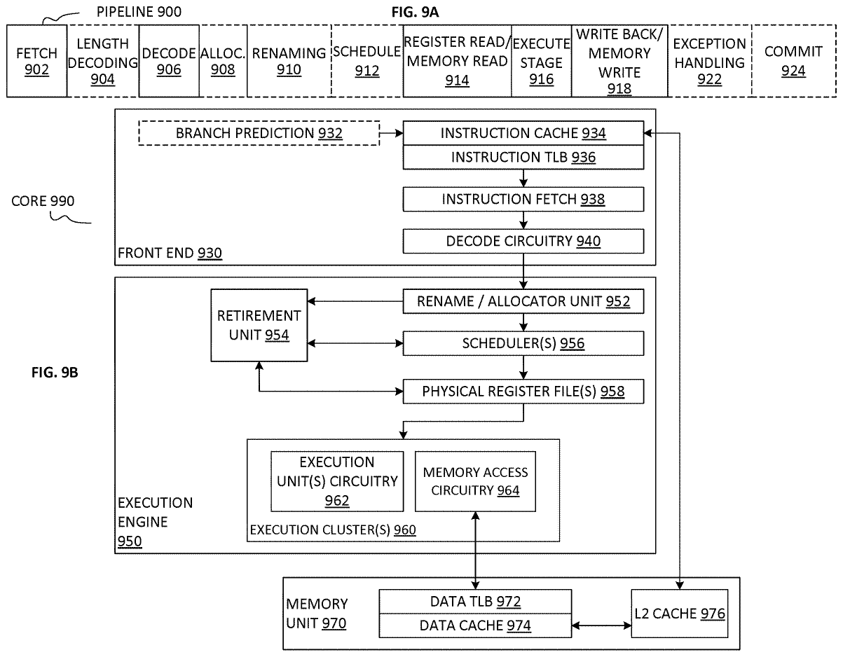

Exemplary Core Architectures—In-order and Out-of-order Core Block Diagram.
FIG. 9A is a block diagram illustrating both an exemplary in-order pipeline and an exemplary register renaming, out-of-order issue/execution pipeline according to examples. FIG. 9B is a block diagram illustrating both an exemplary example of an in-order architecture core and an exemplary register renaming, out-of-order issue/execution architecture core to be included in a processor according to examples. The solid lined boxes in FIGS. 9A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 9A, a processor pipeline 900 includes a fetch stage 902, an optional length decoding stage 904, a decode stage 906, an optional allocation (Alloc) stage 908, an optional renaming stage 910, a schedule (also known as a dispatch or issue) stage 912, an optional register read/memory read stage 914, an execute stage 916, a write back/memory write stage 918, an optional exception handling stage 922, and an optional commit stage 924. One or more operations can be performed in each of these processor pipeline stages. For example, during the fetch stage 902, one or more instructions are fetched from instruction memory, and during the decode stage 906, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 906 and the register read/memory read stage 914 may be combined into one pipeline stage. In one example, during the execute stage 916, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 9B may implement the pipeline 900 as follows: 1) the instruction fetch circuitry 938 performs the fetch and length decoding stages 902 and 904; 2) the decode circuitry 940 performs the decode stage 906; 3) the rename/allocator unit circuitry 952 performs the allocation stage 908 and renaming stage 910; 4) the scheduler(s) circuitry 956 performs the schedule stage 912; 5) the physical register file(s) circuitry 958 and the memory unit circuitry 970 perform the register read/memory read stage 914; the execution cluster(s) 960 perform the execute stage 916; 6) the memory unit circuitry 970 and the physical register file(s) circuitry 958 perform the write back/memory write stage 918; 7) various circuitry may be involved in the exception handling stage 922; and 8) the retirement unit circuitry 954 and the physical register file(s) circuitry 958 perform the commit stage 924.

FIG. 9B shows a processor core 990 including front-end unit circuitry 930 coupled to an execution engine unit circuitry 950, and both are coupled to a memory unit circuitry 970. The core 990 may be a reduced instruction set architecture computing (RISC) core, a complex instruction set architecture computing (CISC) core, a very long instruction word (VLIW) core, or a hybrid or alternative core type. As yet another option, the core 990 may be a special-purpose core, such as, for example, a network or communication core, compression engine, coprocessor core, general purpose computing graphics processing unit (GPGPU) core, graphics core, or the like.

The front end unit circuitry 930 may include branch prediction circuitry 932 coupled to an instruction cache circuitry 934, which is coupled to an instruction translation lookaside buffer (TLB) 936, which is coupled to instruction fetch circuitry 938, which is coupled to decode circuitry 940. In one example, the instruction cache circuitry 934 is included in the memory unit circuitry 970 rather than the front-end circuitry 930. The decode circuitry 940 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 940 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 940 may be implemented using various different mechanisms. Examples of suitable mechanisms include, but are not limited to, look-up tables, hardware implementations, programmable logic arrays (PLAs), microcode read only memories (ROMs), etc. In one example, the core 990 includes a microcode ROM (not shown) or other medium that stores microcode for certain macroinstructions (e.g., in decode circuitry 940 or otherwise within the front end circuitry 930). In one example, the decode circuitry 940 includes a micro-operation (micro-op) or operation cache (not shown) to hold/cache decoded operations, micro-tags, or micro-operations generated during the decode or other stages of the processor pipeline 900. The decode circuitry 940 may be coupled to rename/allocator unit circuitry 952 in the execution engine circuitry 950.

The execution engine circuitry 950 includes the rename/allocator unit circuitry 952 coupled to a retirement unit circuitry 954 and a set of one or more scheduler(s) circuitry 956. The scheduler(s) circuitry 956 represents any number of different schedulers, including reservations stations, central instruction window, etc. In some examples, the scheduler(s) circuitry 956 can include arithmetic logic unit (ALU) scheduler/scheduling circuitry, ALU queues, arithmetic generation unit (AGU) scheduler/scheduling circuitry, AGU queues, etc. The scheduler(s) circuitry 956 is coupled to the physical register file(s) circuitry 958. Each of the physical register file(s) circuitry 958 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 958 includes vector registers unit circuitry, writemask registers unit circuitry, and scalar register unit circuitry. These register units may provide architectural vector registers, vector mask registers, general-purpose registers, etc. The physical register file(s) circuitry 958 is coupled to the retirement unit circuitry 954 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 954 and the physical register file(s) circuitry 958 are coupled to the execution cluster(s) 960. The execution cluster(s) 960 includes a set of one or more execution unit(s) circuitry 962 and a set of one or more memory access circuitry 964. The execution unit(s) circuitry 962 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 956, physical register file(s) circuitry 958, and execution cluster(s) 960 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster- and in the case of a separate memory access pipeline, certain examples are implemented in which only the execution cluster of this pipeline has the memory access unit(s) circuitry 964). It should also be understood that where separate pipelines are used, one or more of these pipelines may be out-of-order issue/execution and the rest in-order.

In some examples, the execution engine unit circuitry 950 may perform load store unit (LSU) address/data pipelining to an Advanced Microcontroller Bus (AMB) interface (not shown), and address phase and writeback, data phase load, store, and branches.

The set of memory access circuitry 964 is coupled to the memory unit circuitry 970, which includes data TLB circuitry 972 coupled to a data cache circuitry 974 coupled to a level 2 (L2) cache circuitry 976. In one exemplary example, the memory access circuitry 964 may include a load unit circuitry, a store address unit circuit, and a store data unit circuitry, each of which is coupled to the data TLB circuitry 972 in the memory unit circuitry 970. The instruction cache circuitry 934 is further coupled to the level 2 (L2) cache circuitry 976 in the memory unit circuitry 970. In one example, the instruction cache 934 and the data cache 974 are combined into a single instruction and data cache (not shown) in L2 cache circuitry 976, a level 3 (L3) cache circuitry (not shown), and/or main memory. The L2 cache circuitry 976 is coupled to one or more other levels of cache and eventually to a main memory.

The core 990 may support one or more instruction sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 990 includes logic to support a packed data instruction set architecture extension (e.g., AVX1, AVX2), thereby allowing the operations used by many multimedia applications to be performed using packed data.

### Exemplary Execution Unit(s) Circuitry.

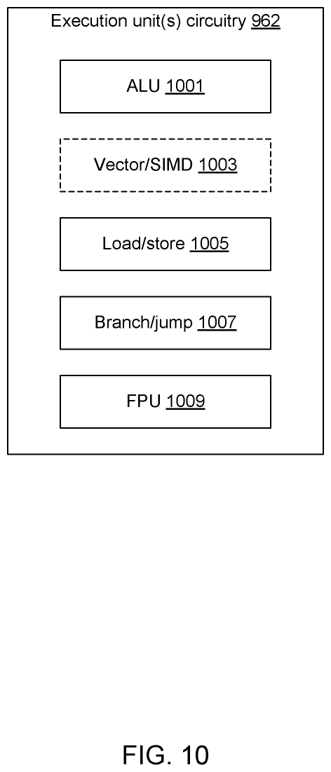

FIG. 10 illustrates examples of execution unit(s) circuitry, such as execution unit(s) circuitry 962 of FIG. 9B. As illustrated, execution unit(s) circuity 962 may include one or more ALU circuits 1001, optional vector/single instruction multiple data (SIMD) circuits 1003, load/store circuits 1005, branch/jump circuits 1007, and/or Floating-point unit (FPU) circuits 1009. ALU circuits 1001 perform integer arithmetic and/or Boolean operations. Vector/SIMD circuits 1003 perform vector/SIMD operations on packed data (such as SIMD/vector registers). Load/store circuits 1005 execute load and store instructions to load data from memory into registers or store from registers to memory. Load/store circuits 1005 may also generate addresses. Branch/jump circuits 1007 cause a branch or jump to a memory address depending on the instruction. FPU circuits 1009 perform floating-point arithmetic. The width of the execution unit(s) circuitry 962 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Exemplary Register Architecture

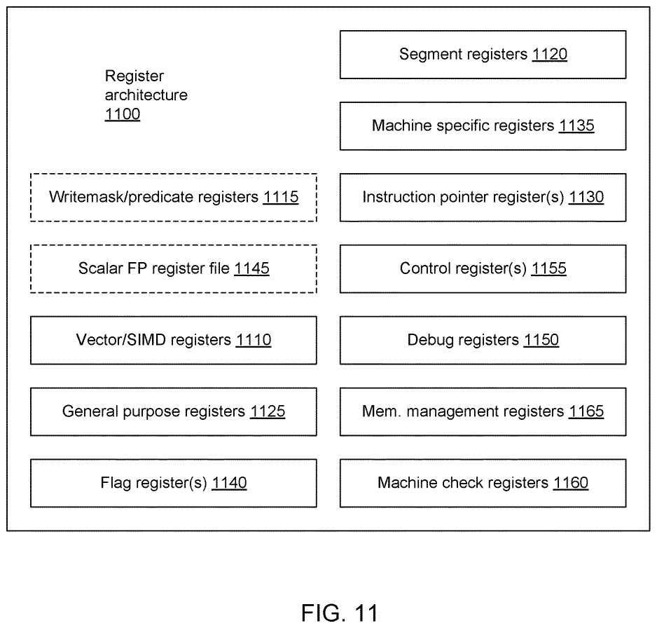

FIG. 11 is a block diagram of a register architecture 1100 according to some examples. As illustrated, the register architecture 1100 includes vector/SIMD registers 1110 that vary from 128-bit to 1,024 bits width. In some examples, the vector/SIMD registers 1110 are physically 512-bits and, depending upon the mapping, only some of the lower bits are used. For example, in some examples, the vector/SIMD registers 1110 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1100 includes writemask/predicate registers 1115. For example, in some examples, there are 8 writemask/predicate registers (sometimes called k0 through k7) that are each 16-bit, 32-bit, 64-bit, or 128-bit in size. Writemask/predicate registers 1115 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1115 corresponds to a data element position of the destination. In other examples, the writemask/predicate registers 1115 are scalable and consist of a set number of enable bits for a given vector element (e.g., 8 enable bits per 64-bit vector element).

The register architecture 1100 includes a plurality of general-purpose registers 1125. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1100 includes scalar floating-point (FP) register 1145 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1140 (e.g., EFLAGS, RFLAGS, etc.) store status and control information for arithmetic, compare, and system operations. For example, the one or more flag registers 1140 may store condition code information such as carry, parity, auxiliary carry, zero, sign, and overflow. In some examples, the one or more flag registers 1140 are called program status and control registers.

Segment registers 1120 contain segment pointers for use in accessing memory. In some examples, these registers are referenced by the names CS, DS, SS, ES, FS, and GS.

Machine specific registers (MSRs) 1135 control and report on processor performance. Most MSRs 1135 handle system-related functions and are not accessible to an application program. Machine check registers 1160 consist of control, status, and error reporting MSRs that are used to detect and report on hardware errors.

One or more instruction pointer register(s) 1130 store an instruction pointer value. Control register(s) 1155 (e.g., CR0-CR4) determine the operating mode of a processor (e.g., processor 770, 780, 738, 715, and/or 800) and the characteristics of a currently executing task. Debug registers 1150 control and allow for the monitoring of a processor or core's debugging operations.

Memory (mem) management registers 1165 specify the locations of data structures used in protected mode memory management. These registers may include a GDTR, IDTR, task register, and a LDTR register.

Alternative examples may use wider or narrower registers. Additionally, alternative examples may use more, less, or different register files and registers. The register architecture 1100 may, for example, be used in physical register file(s) circuitry 958.

Techniques and architectures for performing address translation are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

In one or more first embodiments, a device comprises first circuitry to identify a first address of a first memory access request and to perform an evaluation to identify a registered address set which comprises the first address, and second circuitry coupled to the first circuitry, wherein the second circuitry is to perform a selection between multiple paths based on a result of the evaluation, wherein the multiple paths are to comprise a first path to a pipeline which is to perform address translation with a translation lookaside buffer (TLB), and a second path to a sequestration resource, wherein the second circuitry is further to communicate the first address based on the selection.

In one or more second embodiments, further to the first embodiment, the device further comprises third circuitry coupled to the first circuitry, the third circuitry to maintain a registry of one or more filters which are currently enabled, wherein the one or more filters each correspond to a respective address set, and the first circuitry to perform the evaluation comprises the first circuitry to access the registry.

In one or more third embodiments, further to the first embodiment or the second embodiment, the first circuitry is to detect a failure of the evaluation, the first circuitry is to signal the second circuitry to select the first path based on the failure, and based on the failure, the first circuitry is further to identify a first address set which comprises the first address, and register the first address set as corresponding to a first filter.

In one or more fourth embodiments, further to any of the first through third embodiments, the first circuitry is to detect that the evaluation has resulted in an identification of a first address set, and the second circuitry is to select the second path based on the identification.

In one or more fifth embodiments, further to the fourth embodiment, the device further comprises third circuitry to detect a translation of a second address which is in the first address set, wherein based on the translation, the third circuitry is to identify translation information based on the translation, retrieve the first address from the sequestration resource, and translate the first address based on the translation information.

In one or more sixth embodiments, further to the fifth embodiment, the device further comprises fourth circuitry which, based on the translation, is to remove a filter from a registry of one or more filters which are currently enabled, wherein the one or more filters each correspond to a respective address set.

In one or more seventh embodiments, further to the fifth embodiment, the third circuitry is to translate multiple addresses based on the translation information and a relative prioritization of the multiple addresses with respect to each other, and the multiple addresses are each in the first address set.

In one or more eighth embodiments, further to any of the first through fourth embodiments, the device further comprises third circuitry to receive an indication of an invalidation of one or more entries of the TLB, wherein the third circuitry is to delay a communication of a handshake signal, which is to be based on the indication, until after one or more addresses have been retrieved from the sequestration resource.

In one or more ninth embodiments, further to any of the first through fourth embodiments, a memory management unit comprises the pipeline.

In one or more tenth embodiments, further to the ninth embodiment, the memory management unit is an input-output memory management unit.

In one or more eleventh embodiments, further to any of the first through fourth embodiments, the first circuitry to perform the evaluation comprises the first circuitry to calculate a hash of the first address, and to perform, based on the hash of the first address, a search of a registry of one or more filters which are currently enabled.

In one or more twelfth embodiments, a system comprises a memory, an input-output (IO) device coupled to the memory, an input-output memory management unit (IOMMU), and a filter unit coupled to the IO device and the IOMMU, the filter unit comprising first circuitry to identify a first address of a first memory access request and to perform an evaluation to identify a registered address set which comprises the first address, and second circuitry coupled to the first circuitry, wherein the second circuitry is to perform a selection between multiple paths based on a result of the evaluation, wherein the multiple paths are to comprise a first path to a pipeline of the IOMMU, wherein the pipeline is to perform address translation with a translation lookaside buffer (TLB), and a second path to a sequestration resource, wherein the second circuitry is further to communicate the first address based on the selection.

In one or more thirteenth embodiments, further to the twelfth embodiment, the filter unit further comprises third circuitry coupled to the first circuitry, the third circuitry to maintain a registry of one or more filters which are currently enabled, wherein the one or more filters each correspond to a respective address set, and the first circuitry to perform the evaluation comprises the first circuitry to access the registry.

In one or more fourteenth embodiments, further to the twelfth embodiment or the thirteenth embodiment, the first circuitry is to detect a failure of the evaluation, the first circuitry is to signal the second circuitry to select the first path based on the failure, and based on the failure, the first circuitry is further to identify a first address set which comprises the first address, and register the first address set as corresponding to a first filter.

In one or more fifteenth embodiments, further to any of the twelfth through fourteenth embodiments, the first circuitry is to detect that the evaluation has resulted in an identification of a first address set, and the second circuitry is to select the second path based on the identification.

In one or more sixteenth embodiments, further to the fifteenth embodiment, the filter unit further comprises third circuitry to detect a translation of a second address which is in the first address set, wherein based on the translation, the third circuitry is to identify translation information based on the translation, retrieve the first address from the sequestration resource, and translate the first address based on the translation information.

In one or more seventeenth embodiments, further to the sixteenth embodiment, the filter unit further comprises fourth circuitry which, based on the translation, is to remove a filter from a registry of one or more filters which are currently enabled, wherein the one or more filters each correspond to a respective address set.

In one or more eighteenth embodiments, further to the sixteenth embodiment, the third circuitry is to translate multiple addresses based on the translation information and a relative prioritization of the multiple addresses with respect to each other, and the multiple addresses are each in the first address set.

In one or more nineteenth embodiments, further to any of the twelfth through fifteenth embodiments, the filter unit further comprises third circuitry to receive an indication of an invalidation of one or more entries of the TLB, wherein the third circuitry is to delay a communication of a handshake signal, which is to be based on the indication, until after one or more addresses have been retrieved from the sequestration resource.

In one or more twentieth embodiments, further to any of the twelfth through fifteenth embodiments, the first circuitry to perform the evaluation comprises the first circuitry to calculate a hash of the first address, and to perform, based on the hash of the first address, a search of a registry of one or more filters which are currently enabled.

In one or more twenty-first embodiments, a method comprises identifying a first address of a first memory access request, performing an evaluation to identify a registered address set which comprises the first address, performing a selection between multiple paths based on a result of the evaluation, wherein the multiple paths comprise a first path to a pipeline which performs address translations with a translation lookaside buffer (TLB), and a second path to a sequestration resource, and communicating the first address based on the selection.

In one or more twenty-second embodiments, further to the twenty-first embodiment, the method further comprises maintaining a registry of one or more filters which are currently enabled, wherein the one or more filters each correspond to a respective address set, and performing the evaluation comprises accessing the registry.

In one or more twenty-third embodiments, further to the twenty-first embodiment or the twenty-second embodiment, the first path is selected based on a failure of the evaluation, and the method further comprises based on the failure identifying a first address set which comprises the first address, and registering the first address set as corresponding to a first filter.

In one or more twenty-fourth embodiments, further to any of the twenty-first through twenty-third embodiments, the evaluation results in an identification of a first address set, and the second path is selected based on the identification.

In one or more twenty-fifth embodiments, further to the twenty-fourth embodiment, the method further comprises detecting a translation of a second address which is in the first address set, and based on the translation identifying translation information based on the translation, retrieving the first address from the sequestration resource, and translating the first address based on the translation information.

In one or more twenty-sixth embodiments, further to the twenty-fifth embodiment, the method further comprises based on the translation, removing a filter from a registry of one or more filters which are currently enabled, wherein the one or more filters each correspond to a respective address set.

In one or more twenty-seventh embodiments, further to the twenty-fifth embodiment, multiple addresses are translated based on the translation information and a relative prioritization of the multiple addresses with respect to each other, and the multiple addresses are each in the first address set.

In one or more twenty-eighth embodiments, further to any of the twenty-first through twenty-fourth embodiments, the method further comprises receiving an indication of an invalidation of one or more entries of the TLB, and delaying a communication of a handshake signal, which based on the indication, until after one or more addresses have been retrieved from the sequestration resource.

In one or more twenty-ninth embodiments, further to any of the twenty-first through twenty-fourth embodiments, a memory management unit comprises the pipeline.

In one or more thirtieth embodiments, further to the twenty-ninth embodiment, the memory management unit is an input-output memory management unit.

In one or more thirty-first embodiments, further to any of the twenty-first through twenty-fourth embodiments, performing the evaluation comprises calculating a hash of the first address, and based on the hash of the first address, performing a search of a registry of one or more filters which are currently enabled.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A device comprising:
first circuitry to identify a first address of a first memory access request and to perform an evaluation to identify a registered address set which comprises the first address; and
second circuitry coupled to the first circuitry, wherein the second circuitry is to perform a selection between multiple paths based on a result of the evaluation, wherein the multiple paths are to comprise:
a first path to a pipeline which is to perform address translation with a translation lookaside buffer (TLB); and
a second path to a sequestration resource;
wherein the second circuitry is further to communicate the first address based on the selection.

2. The device of claim 1, further comprising third circuitry coupled to the first circuitry, the third circuitry to maintain a registry of one or more filters which are currently enabled;
wherein:
the one or more filters each correspond to a respective address set; and
the first circuitry to perform the evaluation comprises the first circuitry to access the registry.

3. The device of claim 1, wherein:
the first circuitry is to detect a failure of the evaluation;
the first circuitry is to signal the second circuitry to select the first path based on the failure; and
based on the failure, the first circuitry is further to:
identify a first address set which comprises the first address; and
register the first address set as corresponding to a first filter.

4. The device of claim 1, wherein:
the first circuitry is to detect that the evaluation has resulted in an identification of a first address set; and
the second circuitry is to select the second path based on the identification.

5. The device of claim 4, further comprising third circuitry to detect a translation of a second address which is in the first address set, wherein based on the translation, the third circuitry is to:
identify translation information based on the translation;
retrieve the first address from the sequestration resource; and
translate the first address based on the translation information.

6. The device of claim 5, further comprising fourth circuitry which, based on the translation, is to remove a filter from a registry of one or more filters which are currently enabled, wherein the one or more filters each correspond to a respective address set.

7. The device of claim 5, wherein:
the third circuitry is to translate multiple addresses based on the translation information and a relative prioritization of the multiple addresses with respect to each other; and
the multiple addresses are each in the first address set.

8. The device of claim 1, further comprising third circuitry to receive an indication of an invalidation of one or more entries of the TLB, wherein the third circuitry is to delay a communication of a handshake signal, which is to be based on the indication, until after one or more addresses have been retrieved from the sequestration resource.

9. The device of claim 1, wherein a memory management unit comprises the pipeline.

10. The device of claim 1, wherein the first circuitry to perform the evaluation comprises the first circuitry to:
calculate a hash of the first address; and
to perform, based on the hash of the first address, a search of a registry of one or more filters which are currently enabled.

11. A system comprising:
a memory;
an input-output (IO) device coupled to the memory;
an input-output memory management unit (IOMMU); and
a filter unit coupled to the IO device and the IOMMU, the filter unit comprising:
first circuitry to identify a first address of a first memory access request and to perform an evaluation to identify a registered address set which comprises the first address; and
second circuitry coupled to the first circuitry, wherein the second circuitry is to perform a selection between multiple paths based on a result of the evaluation, wherein the multiple paths are to comprise:
a first path to a pipeline of the IOMMU, wherein the pipeline is to perform address translation with a translation lookaside buffer (TLB); and
a second path to a sequestration resource;
wherein the second circuitry is further to communicate the first address based on the selection.

12. The system of claim 11, wherein:
the first circuitry is to detect a failure of the evaluation;
the first circuitry is to signal the second circuitry to select the first path based on the failure; and
based on the failure, the first circuitry is further to:
identify a first address set which comprises the first address; and
register the first address set as corresponding to a first filter.

13. The system of claim 11, wherein:
the first circuitry is to detect that the evaluation has resulted in an identification of a first address set; and
the second circuitry is to select the second path based on the identification.

14. The system of claim 13, wherein the filter unit further comprises third circuitry to detect a translation of a second address which is in the first address set, wherein based on the translation, the third circuitry is to:
identify translation information based on the translation;
retrieve the first address from the sequestration resource; and
translate the first address based on the translation information.

15. The system of claim 14, wherein the filter unit further comprises fourth circuitry which, based on the translation, is to remove a filter from a registry of one or more filters which are currently enabled, wherein the one or more filters each correspond to a respective address set.

16. A method comprising:
identifying a first address of a first memory access request;
performing an evaluation to identify a registered address set which comprises the first address;
performing a selection between multiple paths based on a result of the evaluation, wherein the multiple paths comprise:
a first path to a pipeline which performs address translations with a translation lookaside buffer (TLB); and
a second path to a sequestration resource; and
communicating the first address based on the selection.

17. The method of claim 16, wherein:
the first path is selected based on a failure of the evaluation; and
the method further comprises:
based on the failure:
identifying a first address set which comprises the first address; and
registering the first address set as corresponding to a first filter.

18. The method of claim 16, wherein:
the evaluation results in an identification of a first address set; and
the second path is selected based on the identification.

19. The method of claim 18, further comprising:
detecting a translation of a second address which is in the first address set; and
based on the translation:
identifying translation information based on the translation;
retrieving the first address from the sequestration resource; and
translating the first address based on the translation information.

20. The method of claim 19, further comprising:
based on the translation, removing a filter from a registry of one or more filters which are currently enabled, wherein the one or more filters each correspond to a respective address set.
